(19) United States
(12) Patent Application Publication
(10) Pub. No.: US 2011/0304306 A1
(43) Pub. Date: Dec. 15, 2011

(54) CURRENT MODE CONTROL OF VOLTAGE REGULATORS TO MITIGATE OUTPUT VOLTAGE RIPPLE

(75) Inventors: Loai Galal, Orman (EG); Rinkle Jain, Portland, OR (US)

(73) Assignee: INTEL CORPORATION

(21) Appl. No.: 12/797,275

(22) Filed: Jun. 9, 2010

(51) Int. Cl. G05F 1/10

(52) U.S. Cl. 323/282

(57) ABSTRACT

Methods and systems may provide for the use of a current control feedback loop to reduce ripple in the output voltage of a regulator such as a switched capacitor voltage regulator. The feedback loop could include an error amplifier that conducts a comparison between a reference voltage and an output voltage from the voltage regulator, and adjusts an instantaneous voltage of a switch of the regulator to generate a matching condition between the regulator current and the current drawn by a load coupled to the regulator.

### CROSS-REFERENCE TO RELATED APPLICATIONS

The present application is related to U.S. patent application Ser. No. 12/566,730 filed Sep. 25, 2009.

### BACKGROUND

1. Technical Field

Embodiments generally relate to the mitigation of output voltage ripple in voltage regulators. In particular, embodiments relate to the use of current mode control to mitigate output voltage ripple.

2. Discussion

While the conventional switched capacitor voltage regulator (SCVR) may represent a magnetic-less alternative to inductor-based regulators with regard to CMOS (complementary metal oxide semiconductor) processing and SoC (system on chip) applications, a number of challenges remain. For example, solutions to mitigate voltage ripple in SCVRs could be applicable for only a subset of operating conditions and might present difficulties with regard to overdesign, routing and/or capacitance real estate.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is schematic diagram of an example of a current control feedback loop according to an embodiment;

FIG. 1B is a block diagram of an example of a linear regulator cascaded with a switched capacitor voltage regulator according to an embodiment;

FIG. 2 is a plot of an example of a conventional output voltage curve and an output voltage curve according to an embodiment;

FIG. 3 is a schematic diagram of an example of a phase of an interleaved converter according to an embodiment;

FIG. 4 is a schematic diagram of an example of a voltage regulator according to an embodiment;

FIG. 5 is a schematic diagram of an example of a pair of voltage regulators interleaved according to an embodiment;

FIG. 6 is a block diagram of an example of a system according to an embodiment; and

FIG. 7 is a flowchart of an example of a method of mitigating output voltage ripple according to an embodiment.

### DETAILED DESCRIPTION

Embodiments may provide for a method of mitigating output voltage ripple in a voltage regulator having at least one switch in which a comparison is conducted between a reference voltage and an output voltage from the regulator. The method can also provide for adjusting an instantaneous voltage of the switch based on the comparison. In one example, adjusting the instantaneous voltage generates a matching condition between the voltage regulator current and the current of a load coupled to the voltage regulator.

Embodiments may also provide for an apparatus including a voltage regulator having a switch, and an error amplifier to conduct a comparison between a reference voltage and an output voltage from the voltage regulator. The error amplifier can also adjust an instantaneous voltage of the switch based on the comparison.

Other embodiments could include a system having a processor core, a switched capacitor voltage regulator (SCVR) coupled to the processor core, an error amplifier and a voltage regulator. The SCVR may include a plurality of switches, wherein the SCVR is to use the switches to generate an output voltage based on an input voltage. The error amplifier can conduct a comparison between a reference voltage and the output voltage, and adjust an instantaneous voltage of each of the plurality of switches based on the comparison. The adjustment may generate a matching condition between the SCVR current and the processor core current, wherein the matching condition completely eliminates ripple in the output voltage.

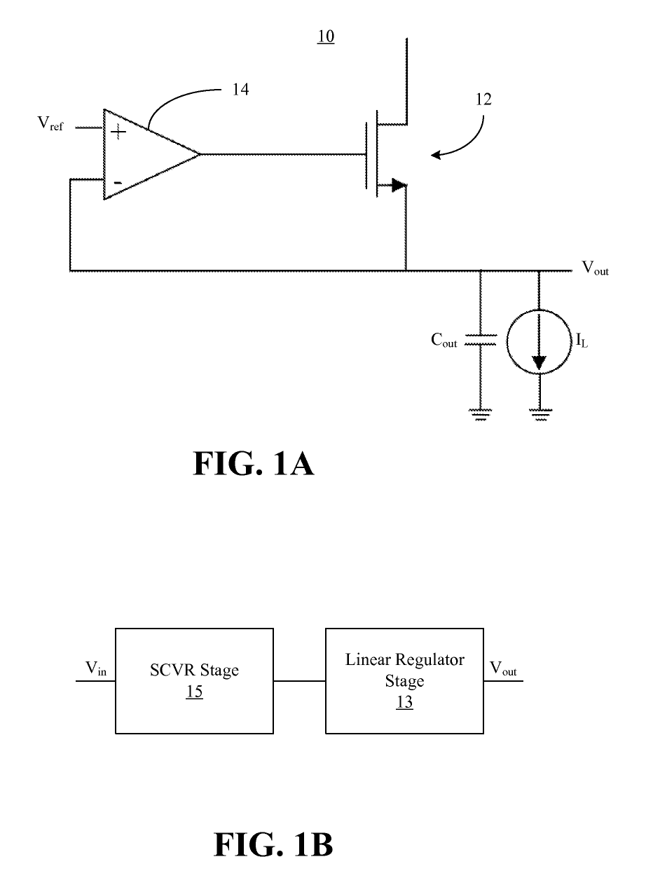

FIG. 1A shows a current control feedback loop (CCFL) 10 in which a switch 12 of a voltage regulator provides an output voltage (Vₒᵤₜ) to a load, which draws a load current (I_{L}). The switch 12 may be coupled to an error amplifier 14 (e.g., a singled ended differential amplifier), which conducts a comparison between a reference voltage (V_{ref}) and the output voltage, and adjusts an instantaneous voltage of the switch 12 based on the comparison. In the illustrated example, the switch 12 is an NMOSFET (n-type metal oxide semiconductor field effect transistor) having a gate terminal coupled to the output of the error amplifier 14 and a source terminal coupled to the output node of the voltage regulator, wherein the instantaneous voltage is the gate to source voltage (V_{GS}) of the NMOSFET. The switch 12 might also be a PMOSFET (p-type MOSFET), another type of transistor, or another type of switch, as appropriate. For example, if the switch 12 were a PMOSFET, the drain terminal of the PMOSFET might be coupled to the output node, wherein the instantaneous voltage that is modulated could be the gate voltage, which inherently adjusts the gate to source voltage. In addition, the switch 12 could be one of multiple output switches, wherein the voltage regulator might be part of an SCVR.

Generally, adjusting the instantaneous voltage of the output switch 12 can generate a matching condition between the current of the voltage regulator and the load current, wherein the matching condition can eliminate ripple in the output voltage. For example, if the output voltage is the voltage across an output capacitor (Cₒᵤₜ) coupled to the output node of the voltage regulator, an equation for the output voltage may be given by,

$${V}_{out} = {V}_{initial} + \frac{1}{{C}_{out}} \int ( {I}_{switch} - {I}_{L} ) d t \qquad ( 1 )$$

Where Vᵢₙᵢₜᵢₐₗ is the output voltage across the capacitor at the start of each switching period at steady state. Assuming that V_{ref}=Vᵢₙᵢₜᵢₐₗ, the small signal output of the error amplifier 14 may be given by,

$${V}_{G} = \frac{A}{{C}_{out}} \int ( {I}_{L} - {I}_{switch} ) d t \qquad ( 2 )$$

Where A is the small signal gain of the error amplifier 14. If the output DC level of the error amplifier 14 is designed to be V_{ref}, then the gate to source voltage of the switch 12 may be expressed as,

$${V}_{GS} = \frac{( A + 1 )}{{C}_{out}} \int ( {I}_{L} - {I}_{switch} ) d t \qquad ( 3 )$$

Thus, in the illustrated example, the current through the switch 12 exponentially converges to the load current value in each switching period. This convergence can represent a matching condition between the current of the voltage regulator and the load current, wherein the rate of convergence may be inversely proportional to 1/Cₒᵤₜ, A, and switch transconductance.

FIG. 1B shows a linear regulator 13 cascaded with an SCVR 15. In order to eliminate ripple in the voltage output by the SCVR 15, the linear regulator 13 may be operated in saturation as well as the triode (e.g., linear) region so that the combined system has the original peak efficiency of the SCVR 15. One approach to implement the illustrated technique would be to embed a linear regulator-like (but periodically switched) control within the SCVR 15.

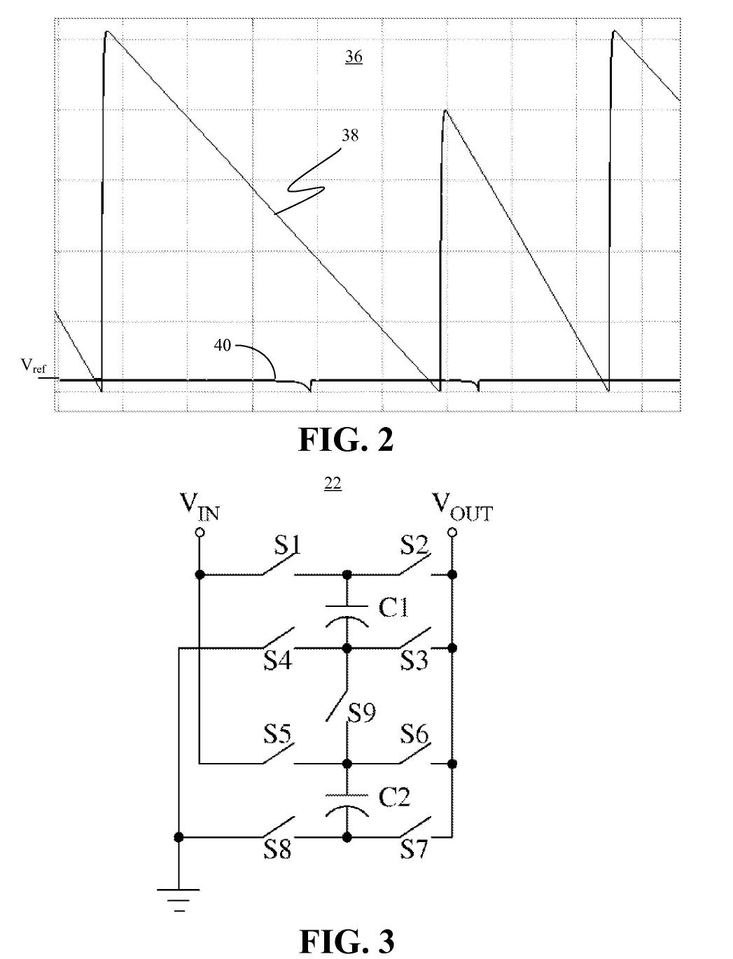

For example, FIG. 2 shows a plot 36 a conventional output voltage curve 38 of a single cell SCVR with hysteretic control, and an output voltage curve 40 that benefits from the current control feedback loop techniques described herein. In the illustrated example, the conventional output voltage curve 38 undergoes large swings and in fact takes the shape of a sawtooth waveform. The improved output voltage curve 40, on the other hand, remains steady at V_{ref} and dips only slightly at the beginning/end of each switching period (assuming the error amplifier has a relatively high gain). Thus, the illustrated output voltage curve 40 has minimal ripple (i.e., a ripple characteristic that is mitigated/reduced to near zero) and provides for enhanced system operation.

Turning now to FIG. 3, one series parallel converter phase 22 of an N-phase interleaved SC (switched capacitor) regulator is shown. In the illustrated example, the converter phase 22 includes flying capacitors C1 and C2, and MOSFETs, modeled as switches S1-S9, which may be operated in two opposite and non-overlapping phases. In particular, a first phase φ₁ can be established by charging the flying capacitors from V_{IN} through switches S1 and S5, and delivering charge from the flying capacitors to V_{OUT} through switches S3 and S7. An opposite and non-overlapping phase φ̅₁ can be established by charging the flying capacitors from the load through switches S4 and S8, and delivering charge from the flying capacitors to V_{OUT} through switches S2 and S6. An example of a truth table for a 2:1 conversion ratio is shown below in Table 1, and an example of a truth table for a 3:1 conversion ratio is shown below in Table 2.

TABLE 1
2:1 Conversion

| SW | φ₁ | φ̅₁̅ |
|---|---|---|
| S1 | ON | OFF |
| S2 | OFF | ON |
| S3 | ON | OFF |
| S4 | OFF | ON |
| S5 | ON | OFF |
| S6 | OFF | ON |
| S7 | ON | OFF |
| S8 | OFF | ON |
| S9 | OFF | OFF |

TABLE 2
3:2 Conversion

| SW | φ₁ | φ̅₁̅ |
|---|---|---|
| S1 | ON | OFF |
| S2 | OFF | ON |
| S3 | ON | OFF |
| S4 | OFF | OFF |
| S5 | ON | OFF |
| S6 | OFF | OFF |
| S7 | ON | OFF |
| S8 | OFF | ON |
| S9 | OFF | ON |

The instantaneous voltage of each of the switches S1-S9 (output switches S2, S3, S6 and S7, in particular) could be adjusted based on a comparison between a reference voltage and the output voltage, as already discussed with regard to switch 12 (FIG. 1). Such an approach can cause the regulator current to converge toward the load current during each switching period and reduce or eliminate ripple from the output voltage. This technique may be used in any switched capacitor converter circuit.

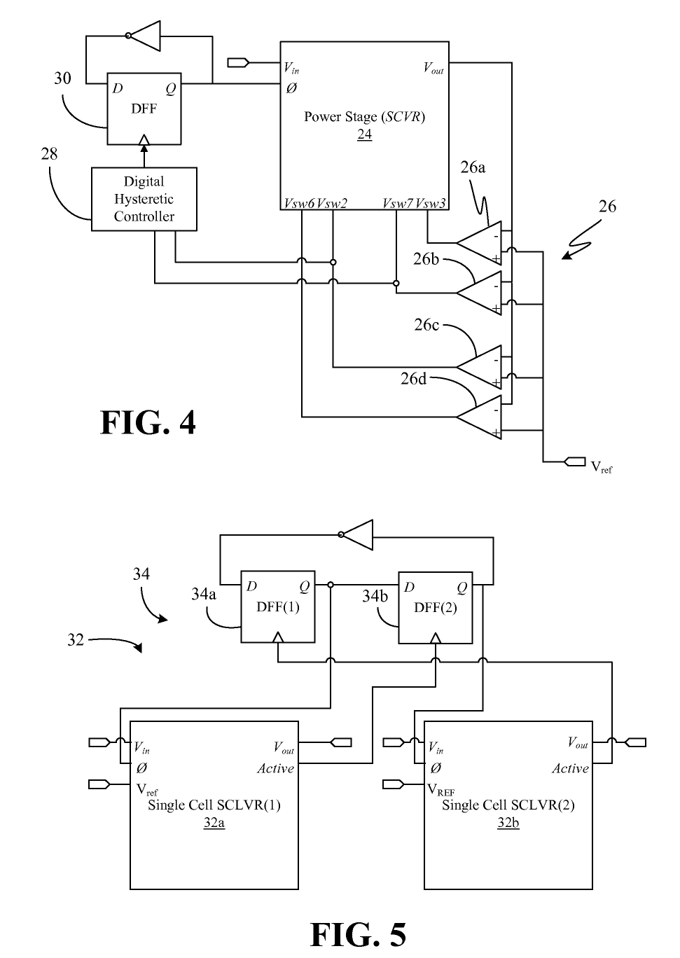

FIG. 4 shows a switched capacitor voltage regulator (SCVR) power stage (e.g., converter) 24, having a plurality of switch inputs (“V_{sw2}”, “V_{sw3}”, “V_{sw6}”, and “V_{sw7}”), which may correspond to the output switches S2, S3, S6 and S7 (FIG. 3), already discussed. The switch inputs may be coupled to the outputs of a corresponding of error amplifiers 26 (26a-26d), wherein the error amplifiers 26 conduct a comparison between a reference voltage and the output voltage of the regulator power stage 24. The static transfer characteristics of the error amplifiers 26 (e.g., differential amplifiers), which might also be compensated for the parasitic capacitances of the switches, can be designed so that the gate to source voltage does not exceed the rating voltage of the switches. The reference voltage may equal the initial voltage of an output capacitor (not shown) coupled to the output of the regulator power stage 24, wherein the illustrated error amplifiers 26 adjust the instantaneous voltage of each of the plurality of switches based on the comparison. A digital hysteretic controller 28 can use the gate voltage of a subset of the plurality of switch inputs (e.g., V_{sw2} and V_{sw7}) to generate the clock signal of a D-type flip-flop (DFF), which determines the phase of the regulator power stage 24.

Turning now to FIG. 5, a pair of voltage regulators 32 (32a-32b) in a 2-cell interleaved design is shown, wherein each regulator 32 may include one or more current control feedback loops 10 (FIG. 1) to eliminate ripple in the output voltage. Thus, each regulator 32 could include a power stage 24, plurality of error amplifiers 26, and digital hysteretic controller 28 (FIG. 4) to generate a matching condition between the regulator current and the load current and produce a clock edge to trigger the DFF 34 (34a-34b) that determines the phase of each cell, as already discussed.

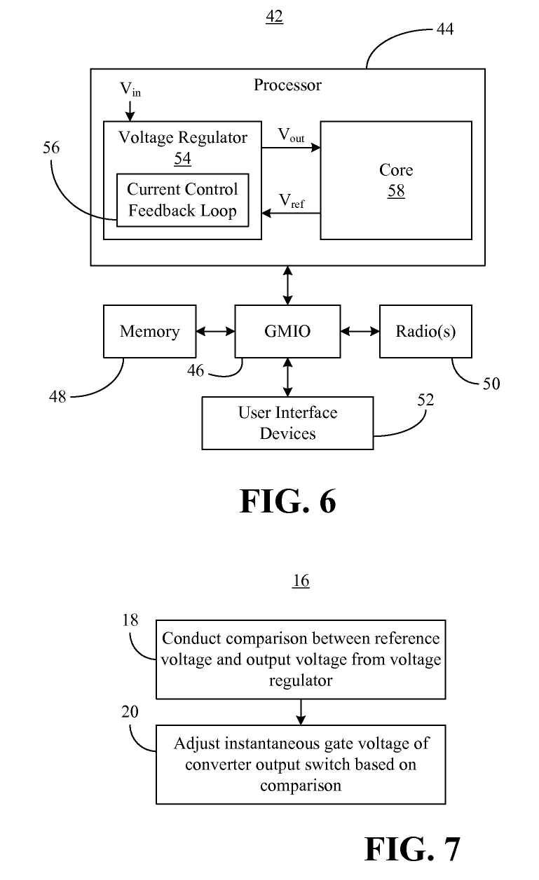

FIG. 6 shows a system 42 that may be a portion of a computing platform such as a test system, design/debug tool, laptop, personal digital assistant (PDA), mobile Internet device (MID), wireless smart phone, media player, imaging device, or any other suitable apparatus. The illustrated system 42 includes one or more processors 44, a graphics/memory/input/output (GMIO) control 46, memory 48, a wireless interface/radio 50, and user interface devices 52. The illustrated processor 44 functions as a host processor that includes a switched-capacitor voltage regulator 54 with one or more current control feedback loops 56, and a processor core 58. The processor 44 could also have a multi-core configuration. A DC input voltage signal/level/potential V_{IN} might be obtained from a battery (not shown) or other rail source that is not directly usable by the processor core 58. Thus, the regulator 54 may convert the input voltage signal into a DC output voltage signal level/potential V_{OUT}, which the processor core 58 can use during operation to perform various computing tasks.

The current control feedback loop 56 may include one or more error amplifiers to conduct a comparison between the reference voltage and the output voltage, and to adjust the instantaneous voltage of one or more internal switches of the regulator 54 based on the comparison, as already discussed. As a result, the current of the regulator 54 can be forced to converge toward the current drawn by the core 58 during each switching period so that the ripple in the output voltage is negligible.

The processor 44 may be coupled to the memory 48, radios 50, and user interface devices 52 through the GMIO control 46. The GMIO control 46 may include one or more blocks (e.g., chips or units within an integrated circuit) to perform various interface control functions (e.g., memory control, graphics control, I/O interface control, and the like). These circuits may be implemented on one or more separate chips and/or may be partially or wholly implemented within the processor 44.

The memory 48 can include one or more memory blocks to provide additional RAM to the processor 44. It may be implemented with any suitable memory including but not limited to dynamic RAM (DRAM), static RAM (SRAM), flash memory, or the like. The radios 50 may wirelessly couple the processor 44 to a wireless network (not shown). The user interface devices 52 may include one or more devices such as a display, keypad, mouse, etc. to allow a user to interact with and perceive information from the system 42. The GMIO control 46, memory 48, radios 50 and/or user interface devices 52 may also include one or more switched capacitor regulators such as the regulator 54.

As already noted, the system 42 may implement a variety of different computing devices or other appliances with computing capability. Such devices include but are not limited to test systems, design/debug tools, laptop computers, notebook computers, PDAs, cellular phones, audio and/or video media players, desktop computers, servers, and the like. The system 42 could constitute one or more complete computing systems or alternatively, it could constitute one or more components useful within a computing system.

FIG. 7 shows a method 16 of mitigating output voltage ripple. The method 16 may be implemented in fixed-functionality hardware using circuit technology such as application specific integrated circuit (ASIC), complementary metal oxide semiconductor (CMOS) or transistor-transistor logic (TTL) technology, or any combination or variation thereof. Processing block 18 provides for conducting a comparison between a reference voltage and an output voltage from a voltage regulator having one or more switches. An instantaneous voltage of at least one switch may be adjusted at block 20 based on the comparison. As already noted, adjusting the instantaneous voltage of the switch can generate a matching condition between the voltage regulator current and the load current.

Thus, the above-described techniques could be used to implement CMOS-based SCVRs that can be used in a wide variety of operating conditions, minimize routing and real estate issues, function as “magnetic-less” circuits and are amenable for on die regulation. Moreover, high conversion efficiency can be realized in SoC applications without a heavy dependency on output capacitance. Indeed, the techniques can be deployed for applications—such as CPU (central processing unit) voltage regulations—that may require small ripple, programmable output voltages and largely varying load conditions. Simply put, solutions described herein can enable single bound control to achieve zero ripple independently of the operating conditions and without the need for larger capacitance.

Embodiments described herein are applicable for use with all types of semiconductor integrated circuit (“IC”) chips. Examples of these IC chips include but are not limited to processors, controllers, chipset components, programmable logic arrays (PLA), memory chips, network chips, and the like. In addition, in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” is used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a processor core;
a switched capacitor voltage regulator coupled to the processor core and having a plurality of switches, the voltage regulator to generate an output voltage based on an input voltage; and
an error amplifier to conduct a comparison between a reference voltage and the output voltage, and to adjust an instantaneous voltage of each of the plurality of switches based on the comparison to generate a matching condition between a current of the voltage regulator and a current of the processor core, wherein the matching condition is to mitigate a ripple characteristic of the output voltage.

2. The system of claim 1, wherein the plurality of switches includes a plurality of field effect transistors (FETs) having terminals coupled to an output node of the voltage regulator, and the instantaneous voltage is to include an instantaneous gate voltage.

3. The system of claim 2, wherein each FET includes at least one of an n-type metal oxide semiconductor (NMOS) FET and a p-type metal oxide semiconductor (PMOS) FET.

4. The system of claim 1, wherein the output voltage is to track the reference voltage.

5. An apparatus comprising:
a voltage regulator having a switch; and
an error amplifier to conduct a comparison between a reference voltage and an output voltage from the voltage regulator, and to adjust an instantaneous voltage of the switch based on the comparison.

6. The apparatus of claim 5, wherein the error amplifier is to adjust the instantaneous voltage to generate a matching condition between a current of the voltage regulator and a current of a load coupled to the voltage regulator.

7. The apparatus of claim 6, wherein the matching condition is to reduce a ripple characteristic of the output voltage.

8. The apparatus of claim 5, wherein the switch includes a field effect transistor (FET) having a terminal coupled to an output node of the voltage regulator, and the instantaneous voltage is to include an instantaneous gate voltage.

9. The apparatus of claim 8, wherein the FET includes at least one of an n-type metal oxide semiconductor (NMOS) FET and a p-type metal oxide semiconductor (PMOS) FET.

10. The apparatus of claim 5, wherein the output voltage is to track the reference voltage.

11. The apparatus of claim 5, wherein the voltage regulator includes a plurality of switches and the apparatus includes a corresponding plurality of error amplifiers to adjust an instantaneous voltage of each of the plurality of switches.

12. The apparatus of claim 5, wherein the voltage regulator includes a switched capacitor voltage regulator.

13. A method comprising:
conducting a comparison between a reference voltage and an output voltage from a voltage regulator having a switch; and
adjusting an instantaneous voltage of the switch based on the comparison.

14. The method of claim 13, wherein adjusting the instantaneous voltage generates a matching condition between a current of the voltage regulator and a current of a load coupled to the voltage regulator.

15. The method of claim 14, wherein the matching condition reduces a ripple characteristic of the output voltage.

16. The method of claim 13, wherein adjusting the instantaneous voltage includes adjusting an instantaneous gate voltage of a field effect transistor (FET).

17. The method of claim 16, wherein adjusting the instantaneous gate voltage includes adjusting the instantaneous gate voltage of at least one of an n-type metal oxide semiconductor (NMOS) FET and a p-type metal oxide semiconductor (PMOS) FET.

18. The method of claim 13, wherein the output voltage tracks the reference voltage.

19. The method of claim 13, wherein the voltage regulator includes a plurality of switches and the method further includes adjusting an instantaneous voltage of each of the plurality of switches.

20. The method of claim 13, wherein conducting the comparison includes comparing the reference voltage to an output voltage from a switched capacitor voltage regulator.
